(19) United States
(12) Patent Application Publication
(10) Pub. No.: US 2010/0260105 A1
(43) Pub. Date: Oct. 14, 2010

(54) DOMAIN TRANSFER SERVICE CONTINUITY PROVISION TO A MOBILE TERMINAL

(76) Inventors: Ralf Keller, Wurselen (DE); Andreas Witzel, Herzogenrath (DE)

Correspondence Address: ERICSSON INC., 6300 LEGACY DRIVE, M/S EVR 1-C-11, PLANO, TX, 75024, US

(21) Appl. No.: 12/746,695

(22) PCT Filed: Dec. 8, 2008
(86) PCT No.: PCT/EP08/67039

§ 371 Date: Jun. 7, 2010

Related U.S. Application Data
(60) Provisional application No. 61/012,148, filed on Dec. 7, 2007.

(51) Int. Cl. H04W 40/00

(52) U.S. Cl. 370/328; 370/352

(57) ABSTRACT

The invention refers to a method of providing a service continuity of a communication between a mobile terminal (UE) and a service node (AS) within a communications network (CN), the communication network comprising a first radio access network (RAN1), a second radio access network (RAN2) and a switching node (MSC), the switching node (MSC) initiating a transfer request towards the service node (AS), while the mobile terminal (UE) is connected to the application server (AS) over the first radio access network (RAN1), transmitting a notification to access the second Radio Access Network (RAN2) to the mobile terminal (UE), receiving a session transfer number from the mobile terminal (UE) addressing the service node (AS) to complete the session transfer, and establishing a communication channel between the mobile terminal and the application server over the second radio access network. The invention further refers to the switching node, a mobility managing node and a computer program.

### TECHNICAL FIELD

The present invention relates to domain transfer between a circuit switched and packet switched domain of a mobile communications network with respect to a terminal.

### BACKGROUND

Mobile communications networks are currently evolving from circuit switched (CS) networks towards packet switched (PS) networks, and by that integrate into Internet Protocol (IP) based infrastructures that are e.g. used for the Internet and the World Wide Web.

So-called IP Multimedia Subsystem (IMS) networks have been developed for delivering multimedia services to mobile terminals (e.g. to GSM terminals being designed according to the well-known standard named Global System for Mobile Communications (GSM), or to Wideband Code Division Multiplex Access (WCDMA) stations. Hereto, calls from and to subscribers of the multimedia services using a CS access are routed through the IMS network in order to reach an IMS service engine. This concept is called IMS Centralized Services (ICS) being described in the standardization document TS 23.292, release 8, of the so-called Third Generation Partnership Project (3GPP) that is a standardization body to produce globally applicable technical specifications.

In the frame of 3GPP, further a project called Long Term Evolution (LTE) has been established to enhance the UMTS mobile phone standard to cope with future requirements, the packet core is evolving to the so-called Evolved Packet Core (EPC) as part of the Evolved Packet System (EPS), supporting the so-called evolved UMTS Terrestrial Radio Access Network (eUTRAN) as new radio access network. As part of these activities, work on voice call continuity for terminal equipped with single radio means, (i.e. terminals with one single radio transmitter and one single radio receiver thus being capable of transmitting/receiving on either PS- or CS-access at a given time such terminal also being referred to as single radio terminals) being referred to as single radio voice call continuity (SR-VCC) is ongoing, enabling to transfer an IMS voice call from the EPS to the CS and vice versa.

In parallel, solutions for providing CS services over packet-oriented access networks (e.g. eUTRAN) are developed. One solution is the so-called “CS Fallback” being described in the standardization document TS 23.272, release 8 of 3GPP named “Circuit Switched Fallback in Evolved Packet System”, which enables a user equipment (UE), in the following also being referred to as user terminal or terminal, to originate or terminate CS calls in a circuit-switched oriented Radio Access Network (e.g. WCDMA/GERAN) even when being active on the packet-oriented access network. This means that the terminal is performing so-called procedures for EPC mobility like PS attach and location update towards the Mobility Management Entity (MME) while still having eUTRAN access. In addition, when the UE attaches to the EPC, the MME registers the terminal in the Mobile Switching Center Server (MSC-S). When a page for CS services is received in the MSC-S, it is forwarded to the MME over the interface between the MSC-S and the MME (this interface sometimes being referred to as SGs reference point as defined in 3GPP TS 23.272 version 8, section 4.2.1 that can be regarded as an enhanced version of the GS interface connecting the MSC and the VLR in GSM). The MME further forwards this information to the terminal, which performs a transition to the circuit switched RAN in response. Such process allows a provisioning of voice and other CS-domain services (e.g. SMS) by reuse of CS infrastructure when the terminal is served by eUTRAN. This fallback can be based on PS handover (i.e. a handover between nodes within the PS-based RAN), cell change order, or terminal based selection of a suitable cell in the CS based RAN. Similar behaviour might apply for terminal originated CS services: when such services are triggered while the terminal has LTE access, it will perform a fallback to a CS based RAN and trigger the initiation of the CS service there.

Single-radio Voice Call continuity based solutions as e.g. proposed for 3GPP accesses by the 3GPP document TS 23.216, release 8, section 6.2 and 6.3 involve an interworking function between the EPC and the CS domain. On the other hand, handover within the RAN area, i.e. between the base station controller of the CS based RAN and the radio network controller of the PS-based RAN (inter-BSC/RNC handover), require resource information (e.g. call info, bearer info or QoS info) to be tunneled via the core network.

### SUMMARY

It is an object of the present invention to improve the transfer between the CS and PS domain. This object is achieved by the independent claims. Advantageous embodiments are described in the dependent claims.

According to embodiments of the invention, a mobile terminal communicates to an application server of a communications network via one of a plurality of radio access networks—RAN- each facilitating a wireless communication between the terminal and the communications network. The RANs can be regarded as a part of the communications network that provides a radio access to the mobile terminal. Usually, each RAN comprises one or a plurality of control nodes and transceiver stations. These stations each serve mobile terminals within a certain region. RANs can be divided into access networks providing to the mobile terminal a circuit switched communication channel, in the following also being referred to as CS providing RAN or CS RAN (e.g. GERAN or UTRAN in combination with the A/luCS interface to the MSC), and access networks providing a packet switched communication channel (e.g. GERAN, UTRAN in combination with the Gb/luPS interface to the SGSN) and eUTRAN), in the following referred to as PS providing RAN or PS RAN. In other words, eUTRAN provides only packet-switched communication while GERAN and UTRAN provide both packet- and circuit-switched communication.

Under certain conditions, e.g. if the mobile terminal is moving out of an certain area, wherein it can be served by a first RAN, a transfer to a second radio access network is to be performed. According to embodiments of the invention, a transfer request is initiated towards the application server (e.g. by one of the mobile terminal or the switching node), while the mobile terminal is connected to the application server over the first radio access network. Previously to initiating the transfer, the switching node might have received a transfer request from the first RAN, e.g. after radio measurements within the terminal. Subsequently, a notification to access the second radio access network is transmitted to the mobile terminal. Further subsequently, the switching node receives a request (e.g. comprising a session transfer number addressing the service node, wherein the session transfer number might be the B-Number of the application server) from the mobile terminal. Subsequently, the switching node controls, supports or performs a completion of the session transfer such that a communication channel is established between the mobile terminal and the application server over the second radio access network.

This embodiment allows for service continuity in case or PS CS handover also in cases wherein the mobile terminal is a single radio terminal as discussed above.

In an embodiment, the first radio access network is a packet-switched—PS-radio access network, e.g. an eUTRAN, and the second radio access network is a circuit-switched—CS-oriented radio access network, e.g. a GERAN/UTRAN.

In an embodiment, the switching node is a mobile switching center (MSC) or a MSC server that initiates or controls the call establishment of the mobile terminal with any communication partner, e.g. the application server, with respect to the CS RAN. In a further embodiment, the switching node is a so-called evolved MSC that is capable of supporting IMS centralized services.

In a further embodiment, the communications network comprises a mobility management node or entity that manages the mobility of the mobile terminal with respect to the PS RAN. Thereto, it manages and stores the mobile terminal context, e.g. generating a temporary identity and allocating it to the mobile terminals.

In an embodiment, the mobile terminal is communicating with the application server via the PS RAN. The switching node receives a relocation request from the mobility management entity, initiates a session transfer request towards the application server, transmits a handover notification to access the CS RAN to the mobile terminal and completes the session transfer by means of a domain transfer identifier. This can be regarded as an extension of the CS Fallback solution described in 3GPP TS 23.272, version 8, which does not allow to establish a session transfer request by the mobile terminal while being in E-UTRAN, thereby providing the capability to provide service continuity for single radio terminals, also being referred to as SRVCC as described in the introduction.

In an embodiment, the switching node receives the domain transfer identifier (STN) from the mobile terminal prior to completing the session transfer.

The present invention also concerns computer programs comprising portions of software codes in order to implement the method as described above when operated by a respective processing unit of a user device and a recipient device. The computer program can be stored on a computer readable medium. The computer-readable medium can be a permanent or rewritable memory within the user device or the recipient device or located externally. The respective computer program can be also transferred to the user device or recipient device for example via a cable or a wireless link as a sequence of signals.

In the following, detailed embodiments of the present invention shall be described in order to give the skilled person a full and complete understanding. However, these embodiments are illustrative and not intended to be limiting.

### BRIEF DESCRIPTION OF THE FIGURES

FIG. 1 shows a block diagram of an exemplary communications network comprising network nodes and exemplary communication relations between the network nodes,

FIG. 2 shows a sequence diagram of a sequence performed in a switching node of the telecommunications network according to the communication relations shown in FIG. 1, and

FIG. 3 shows a sequence diagram of an alternative sequence exemplary protocol sequence performed in a switching node.

### DETAILED DESCRIPTION

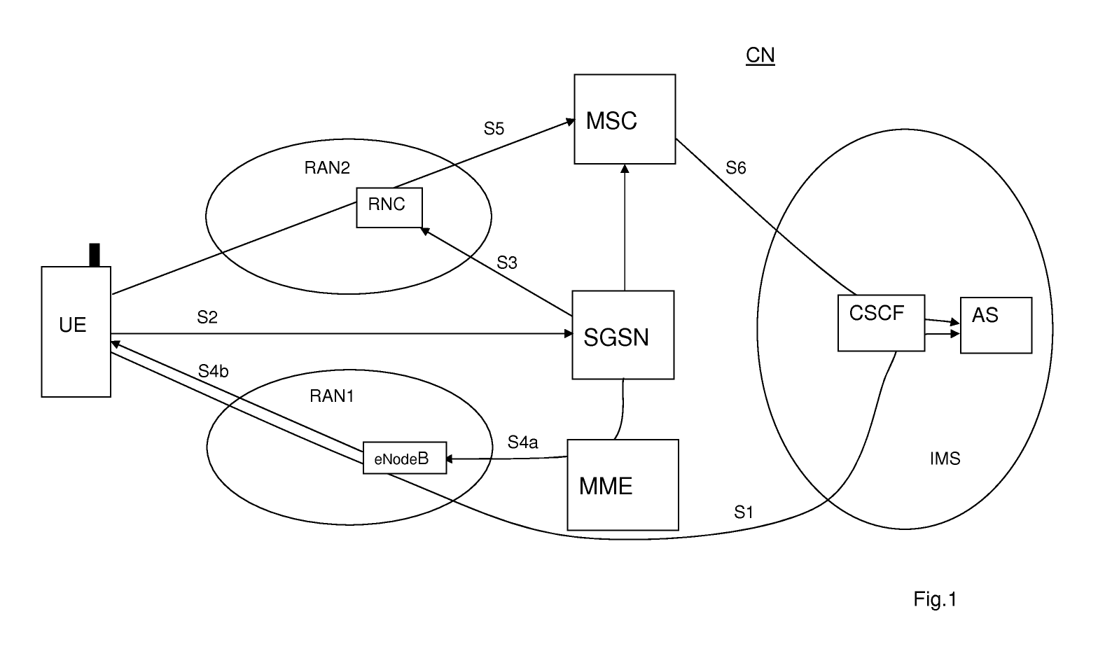

FIG. 1 shows a block diagram of an exemplary telecommunications network CN comprising a switching node MSC, in the following also being referred to as switching server, a so-called serving GPRS Support Node SGSN, in the following also being referred to as service node SGSN, mobility managing entity MME, an IP Multimedia Subsystem IMS, a first radio access network RAN1, and a second radio access network RAN2 each providing a radio access to a mobile terminal UE, also being referred to as user equipment UE. The Subsystem IMS comprises a Call Session Control Function CSCF providing session control for subscribers accessing services within the IMS and an application server AS enabling operators to deploy person-to-person multimedia services in 2G and 3G networks.

Each of the radio access networks RAN1 and RAN2 comprises e.g. one or a plurality of control nodes (e.g. being referred to as radio network controllers in the terminology of UMTS, base station controllers in the terminology of GSM) and transceivers (e.g. being referred to as base transceiver station in the terminology of GSM, NodeB in the terminology of UMTS and evolved NodeB or eNodeB in the terminology of LTE) for providing a physical radio connection to the mobile terminal UE. As discussed above, radio access networks can be divided into access networks providing to the mobile terminal a circuit switched communication channel—CS RAN-, and access networks providing a packet switched communication channel—PS RAN-.

The switching node MSC is a network element (e.g. an MSC Server or an MSC) handling call control and signalling, optionally being enhanced for IMS centralized services. The switching node MSC mainly comprises the call control and mobility control parts of a GSM/UMTS. It might be integrated together with a VLR to hold the mobile subscriber's service data. The switching node MSC terminates the user-network signalling and translates it into the signalling towards the network.

The MME is a signaling-only entity. Its main function is to manage the mobility of the mobile terminal UE, with respect to the packet switched radio access network RAN1. It supports means of personal, service and terminal mobility, i.e., it allows users to access network services anywhere, as well as to continue their ongoing communication and to access network services anywhere using one's own mobile terminal. It further supports global roaming, i.e. it should remain independent of the underlying wireless technology. In addition, the MME might also perform authentication and authorization, idle-mode tracking and reachability, security negotiations, and so-called NAS (non access stratum) signaling. It is involved in the bearer activation/deactivation process and is also responsible for choosing the SGW for a mobile terminal at the initial attach and at time of intra-LTE handover involving Core Network node relocation.

The Support Node SGSN is responsible for the delivery of data packets from and to the mobile terminal UE within its geographical service area with respect to the packet switched radio access network RAN1. Its tasks include packet routing and transfer, mobility management (attach/detach and location management), logical link management, and authentication and charging functions. The location register of the SGSN stores location information (e.g., current cell, current VLR) and user profiles (e.g., IMSI, address(es) used in the packet data network) of all GPRS users registered with the SGSN.

The application server AS is a dedicated application server known as the Service Centralization and Continuity (SCC) application server connected to the IP multimedia subsystem IMS, as any other application server, over a standard ISC interface. The application server thereby might be a call control server (communicating by means of the SIP protocol) controlling a communication from the (first) mobile terminal UE to a second mobile terminal. Therein, the application server switchably connects a first call leg between the first mobile terminal UE and the application server, and a second call leg between the application server and the second mobile terminal. In cases of a domain transfer with respect to the first mobile terminal, the application server switches from connecting the first call leg with the second call leg to connecting a new (third) call leg between the first mobile terminal to the application server with the second call leg. In case of a PS-CS domain transfer with respect to the first mobile terminal, the first call leg can be regarded as PS call leg, and the third call leg can be regarded as CS call leg.

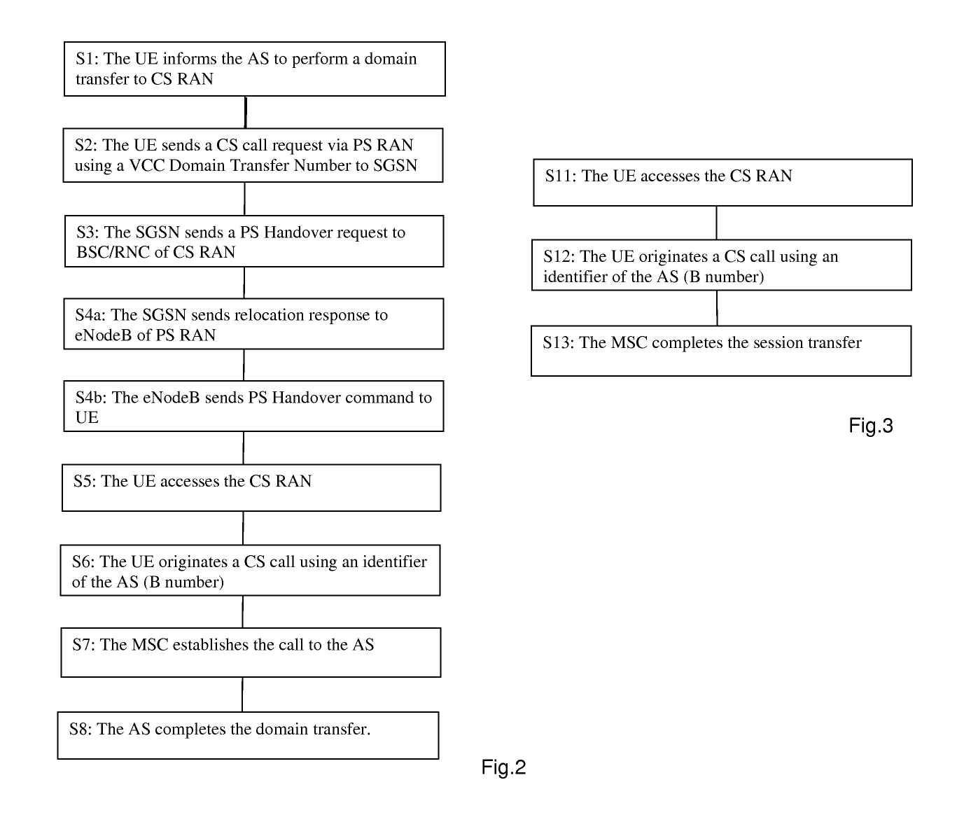

FIG. 1 further shows arrows S1-S8 that symbolise communication or steps of communications between the network nodes and the mobile terminal UE being described in details under the FIG. 2.

In the following, it will assumed that the mobile terminal UE supports access both to the CS domain of the communications network CN over CS RAN (GERAN/UTRAN), and over the PS RAN (eUTRAN) to the corresponding Packet System EPS. It will be further assumed without limitation to the scope of the invention that the mobile terminal is a so-called single-radio terminal; i.e. a terminal that has only one set of transmitter/receiver means to communicate with one of the CS RAM and the PS RAM at a given time.

The mobile terminal UE communicates with the application server AS. Therein, it is connected either via the CS radio access network RAN2 or the PS radio access network RAN1, depending on the location of the mobile terminal, the availability and reachability of transceivers of the radio access networks. PS RAN and CS RAN might overlap in certain regions, or in other words, in these regions the mobile terminal might choose one of both access networks to communicate. While it might be preferred to be connected via the PS RAN (eUTRAN), coverage of this PS RAN might be limited. If the mobile terminal is moving out of the range of the PS RAN, a handover to the CS RAN is necessary to maintain a connection to the network.

The following procedures described under FIG. 2 and FIG. 3 allow for a domain transfer from PS to CS maintaining service continuity. In both procedures, the mobile terminal falls back to CS radio access and then originates a CS session in order to complete the domain transfer (UE originated SRVCC).

FIG. 2 shows a first option for performing a domain transfer between PS and CS, providing single radio service continuity, wherein the following steps S1 to S8 are performed:
S1: The mobile terminal UE informs the Service Centralization and Continuity Application Server—SCC AS-located in the IMS about the need to perform a domain transfer to the CS domain (GSM/WCDMA). When receiving this information, the SCC AS starts to buffer ongoing and newly incoming SIP procedures until the session is re-established via the CS leg,
S2: the mobile terminal UE sends a CS call request via PS RAN (eUTRAN) using a VCC Domain Transfer Number—VDN-, turned into a relocation request towards the Serving GPRS Support Node—SGSN- (note: VDN/VDI is optional),
S3: the SGSN sends a PS Handover request to the CS RAN (BSC/RNC),
S4: a) the BSC/RNC sends a corresponding relocation response;
   b) the PS RAN (eNodeB) sends a PS Handover command to the mobile terminal UE (S4b),
S5: the mobile terminal UE accesses the CS RAN (GERAN/UTRAN),
S6: the mobile terminal UE originates a CS call using a certain domain transfer identifier (VDN) as B number of the SCCAS to perform a Session Transfer of the media path from PS to CS access,
S7: the switching node MSC establishes the call to the SCCAS, and
S8: the SCCAS connects the remote end to the CS leg via the switching node MSC.

FIG. 3 shown an alternative embodiment being similar in parts to the above-described sequence, but replacing the first steps S1-S4 e.g. by steps defined in TS 23.216 v 8.1.0, section 6.2.2 and 6.3.2, the MSC Server has, upon receiving the relocation request from the MME, initiated the session transfer request towards the SCC AS. The following steps S11-S12 are performed:
S11: after receiving the handover (HO) notification, the UE accesses the CS RAN (GERAN/UTRAN),
S12: the UE originates a CS call using domain transfer identifier (STN) as B number,
S13: The MSC, which had initiated the session transfer request towards the SCC AS beforehand, completes the session setup by connecting the call leg established by the UE with the already established call leg towards the SCC AS.

This solution enables that both UE and MSC have synchronized their states, including the Transaction Identifier (included in the session transfer request issued by the mobile terminal UE).

In a further alternative the application server (SCC AS) issues a terminated session which causes the MSC to page the mobile terminal UE in the CS RAN (eUTRAN) such that the UE moves to CS domain (CS fallback) and then completes the session transfer (network originated SRVCC). This option does not rely on PS-PS handover, however, relies on the application server to initiate a terminating call to the CS domain. The following steps S21-S27 are performed:
S21: The mobile terminal UE informs the SCC AS (DTF) about the need to perform a domain transfer to GSM/WCDMA. When receiving this information, the SCC AS starts to buffer ongoing and newly incoming SIP procedures until the session is re-established via the CS leg.
S22: Network-initiated domain transfer: the SCC AS initiates a terminating CS call.
S23: The MSC pages the mobile terminal UE via the GS+ interface; the MME forwards the paging indication to the UE using a tunnel through EPS (as for fallback to CS).
S24: The mobile terminal UE accesses the CS RAN (fallback).
S25: Page Response is sent via the CS RAN to the MSC.
S26: The MSC establishes the call to the SCC AS
S27: The SCC AS connects the remote end to the CS leg via the MSC.

The communications between MME and MSC might be based on the so-called SGs using originated session. SGs, also being referred to as reference point Gs+, is based on the reference point Gs defined as interface between the SGSN and MSC server and is used for the mobility management and paging procedures between PS and CS domain as described in 3GPP TS 23.060.

This option relies on a handover within the PS (PS-PS handover), which might require dual transfer mode (DTM) capabilities at least in the mobile terminal UE, and uses normal UE session establishment procedure.

1. A method of providing service continuity of a communication between a mobile terminal and a service node within a communications network, the communication network comprising a first radio access network, a second radio access network and a switching node, the switching node performing the following steps:
transmitting a notification to access the second Radio Access Network to the mobile terminal, while the mobile terminal is connected to the application server over the first radio access network,
receiving a request from the mobile terminal to complete the session transfer, and
establishing a communication channel between the mobile terminal and the application server over the second radio access network.

2. The method of claim 1, wherein the switching node initiates the transfer request towards the service node, while the mobile terminal is connected to the application server over the first radio access network.

3. The method of claim 1, wherein the response from the mobile terminal comprises a session transfer number addressing the service node.

4. The method of claim 1, wherein the first radio access network is an access network for providing a packet switched communication channel between the mobile terminal and the application server, and the second radio access network is an access network for providing a circuit switched communication channel between the mobile terminal and the application server, wherein the switching node completes the session transfer by connecting a first call leg established by the UE towards the switching node with a second call leg from the switching node towards the application server.

5. The method of claim 1, wherein the communications network comprises a mobility server for managing the mobility of mobile terminal with respect to the first radio access network wherein the switching node receives a relocation request from the mobility server prior to the initiation of the transfer request towards the service node.

6. The method of claim 4, wherein the session transfer number comprises a telephone number addressing the application server, and the switching node detecting said telephone number to initiate the second call leg from the switching node towards the application server.

7. The method of claim 6, wherein the CS registration of the mobile terminal is initiated based on procedures of the SGs reference point.

8. A switching node for providing a service continuity of a communication between a mobile terminal and a service node over a communications network, the communication network comprising a first radio access network and a second radio access network the switching node comprising:
a transmitter for transmitting a notification to access the second Radio Access Network to the mobile terminal,
a receiver for receiving a request to the notification from the mobile terminal, and
control means for establishing a communication channel to the application server.

9. The method of claim 8, the switching node further being adapted for initiating a transfer request towards the service node, while the mobile terminal is connected to the application server over the first radio access network.

10. A communications network, for providing a service continuity of a communication between a mobile terminal and a service node, the communication network comprising a first radio access network, a second radio access network and a switching node, the communications network comprising:
the switching node for transmitting a notification to access the second Radio Access Network to the mobile terminal after initiation of a transfer request towards the service node,
the switching node for receiving a response from the mobile terminal to complete the session transfer, and
the switching node for establishing a communication channel between the mobile terminal and the application server.

11. The communications network of claim 10, wherein the communications network further comprises a support node (SGSN) for providing a packet service over the second radio access network to the mobile terminal, further comprising:
the SGSN for sending a handover request to the second radio access network to be transformed into a relocation response and to be transmitted to the mobile terminal.

12. The communications network of claim 12, further comprising a mobility management server for managing a mobility of the mobile terminal with respect to the packet switched radio access network further comprising
a mobility management server for transmitting a relocation request to the switching node prior to the transmission of the notification to access the second Radio Access Network to the mobile terminal.

13. The communications network of the preceding claim, wherein the service node is adapted to receive an indication by the mobile terminal to perform a domain transfer to the CS domain.

14. (canceled)
